(19) United States
(12) Patent Application Publication
(10) Pub. No.: US 2019/0017286 A1
(43) Pub. Date: Jan. 17, 2019

(54) SYSTEMS AND MOUNTING APPARATUSES FOR SUPPORTING ELEVATED STRUCTURES

(71) Applicant: Akram Hossain, Munster, IN (US)

(72) Inventor: Akram Hossain, Munster, IN (US)

(21) Appl. No.: 16/120,824

(22) Filed: Sep. 4, 2018

Related U.S. Application Data
(63) Continuation-in-part of application No. 15/647,801, filed on Jul. 12, 2017.

(51) Int. Cl. E04H 12/22; F16M 13/02; F16B 2/06

(52) U.S. Cl. CPC E04H 12/2269; F16B 2/065; F16M 13/02

(57) ABSTRACT

Systems and mounting apparatuses for removably securing a pole to a structure, for example, to support a bird house or animal feeder. The mounting apparatuses include an outer member having an elongated wall defining at least a portion of an internal cavity and an end opening thereto configured to receive the pole. Features are provided for fixing the mounting apparatus to the structure. An inner member located within the internal cavity is elongated in a direction parallel to the longitudinal axis of the outer member and has a cross-sectional shape congruous or otherwise complementary to an exterior surface of the pole. A feature provides the capability to move the inner member within the internal cavity in directions perpendicular to the longitudinal axis of the outer member in order to secure the pole within the internal cavity by moving the inner member toward the pole to contact and apply pressure thereto.

### CROSS REFERENCE TO RELATED APPLICATIONS

This is a continuation-in-part patent application of co-pending U.S. patent application Ser. No. 15/647,801, filed Jul. 12, 2017.

### BACKGROUND OF THE INVENTION

The present invention generally relates to support systems for supporting structures intended to be elevated, including but not limited to bird houses and animal feeders. The invention particularly relates to systems that include mounting apparatuses that are configured to clamp a pole to such an elevated structure and to a rigid base structure that is able to support the elevated structure through the pole.

In general, bird houses and animal feeders are preferentially located at elevated locations above the ground so as to protect these elevated structures from tampering by animals such as raccoons or squirrels. Mounting systems currently available may include a pole coupled to a rigid base structure via a mounting device. Some of these mounting devices secure the pole with a pin, bolt, or the like which contacts the pole at effectively a single point. Such systems can be prone to damage or wear due to the stresses applied at the point of contact between the mounting device and the pole. In addition, these systems may be difficult to adjust and/or remove for cleaning the bird house or animal feeder and/or refilling the animal feeder.

In view of the above, it can be appreciated that it would be desirable if an improved system were available for supporting elevated structures that was capable of at least partly overcoming or avoiding problems, shortcomings or disadvantages of the prior art.

### BRIEF DESCRIPTION OF THE INVENTION

The present invention provides mounting systems suitable for supporting structures intended to be elevated, including but not limited to bird houses and animal feeders, and to mounting apparatuses for removably securing a pole to an elevated structure and/or to a base structure used to support the elevated structure with the pole.

According to one aspect of the invention, a mounting apparatus includes an outer member having a longitudinal axis, an elongated wall that defines at least a portion of an internal cavity that is at least partially enclosed by the elongated wall and configured to receive a pole, an end opening to the cavity configured for receiving the pole, and means for securing the mounting apparatus to a structure. The mounting apparatus further includes an inner member located within the cavity defined by the outer member, elongated in a direction parallel to the longitudinal axis of the outer member, and having a cross-sectional shape congruous or otherwise complementary to an exterior surface of the pole. Means is provided for moving the inner member within the cavity in directions perpendicular to the longitudinal axis of the outer member. The mounting apparatus is configured to secure the pole within the cavity by moving the inner member toward the pole and into surface-to-surface contact with the pole and to apply surface pressure to the pole.

According to another aspect of the invention, a system is provided for mounting a first structure in an elevated position relative to a base structure. The system includes a rigid pole configured to hold the elevated structure in the elevated position, first and second mounting apparatuses, means for securing the first mounting apparatus to the first structure, and means for securing the second mounting apparatus to the base structure. Each of the first and second mounting apparatuses includes an outer member having a longitudinal axis, an elongated wall that defines at least a portion of an internal cavity that is at least partially enclosed by the elongated wall and configured to receive a pole, an end opening to the cavity configured for receiving the pole. An inner member is located within the cavity, is elongated in a direction parallel to the longitudinal axis of the outer member, and has a cross-sectional shape congruous or otherwise complementary to an exterior surface of the pole. Means is provided for moving the inner member within the cavity in directions perpendicular to the longitudinal axis of the outer member. The mounting apparatuses are each configured to secure the pole within the cavity thereof by moving the inner member thereof toward the pole and into surface-to-surface contact with the pole and to apply surface pressure to the pole.

Technical effects of the system and mounting apparatus described above preferably include the ability to support an elevated structure, such as a bird house or animal feeder, in a fixed elevated position while allowing for disassembly in a manner that promotes ease of use and reduced wear.

Other aspects and advantages of this invention will be further appreciated from the following detailed description.

### BRIEF DESCRIPTION OF THE DRAWINGS

It should be noted that the drawings are drawn for purposes of clarity when viewed in combination with the following description, and therefore are not necessarily to scale.

FIGS. 1 through 3 represent systems that each includes a pole and two mounting apparatuses that cooperate to support a structure to be elevated, such as a bird house or bird feed, relative to a rigid base structure in accordance with nonlimiting aspects of the invention.

FIG. 4 represents a perspective view of a first of the mounting apparatuses securing the pole to the base structure in accordance with nonlimiting aspects of the invention.

FIG. 5 represents a top view of the first mounting apparatus of FIG. 4.

FIG. 6 represents an isolated view of an inner member of the first mounting apparatus of FIGS. 4 and 5 with an adjustment bolt fixed thereto.

FIG. 7 represents a perspective view of a second of the mounting apparatuses securing the pole to the base structure in accordance with nonlimiting aspects of the invention.

FIG. 8 represents a top view of the second mounting apparatus of FIG. 7.

FIG. 9 represents a third mounting apparatus in accordance with nonlimiting aspects of the invention.

### DETAILED DESCRIPTION OF THE INVENTION

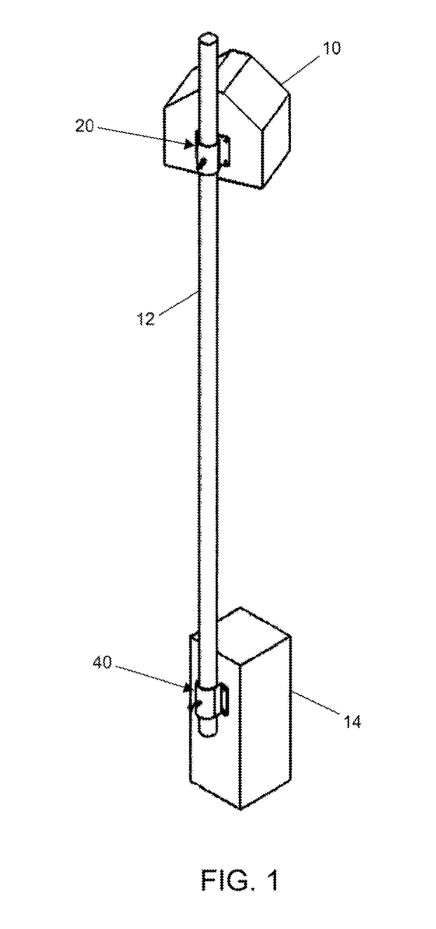

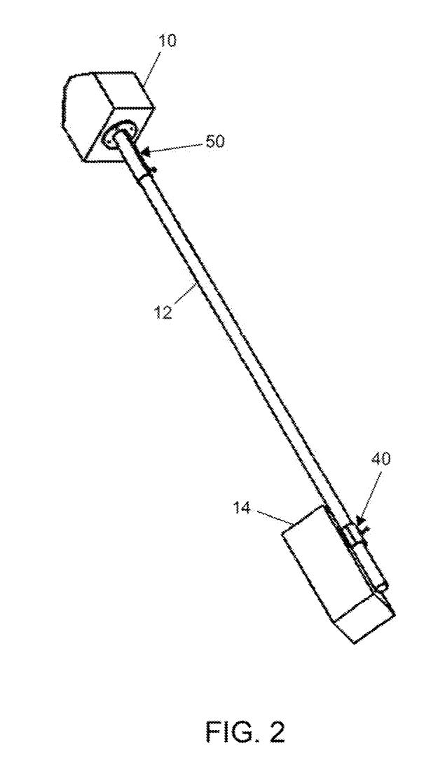

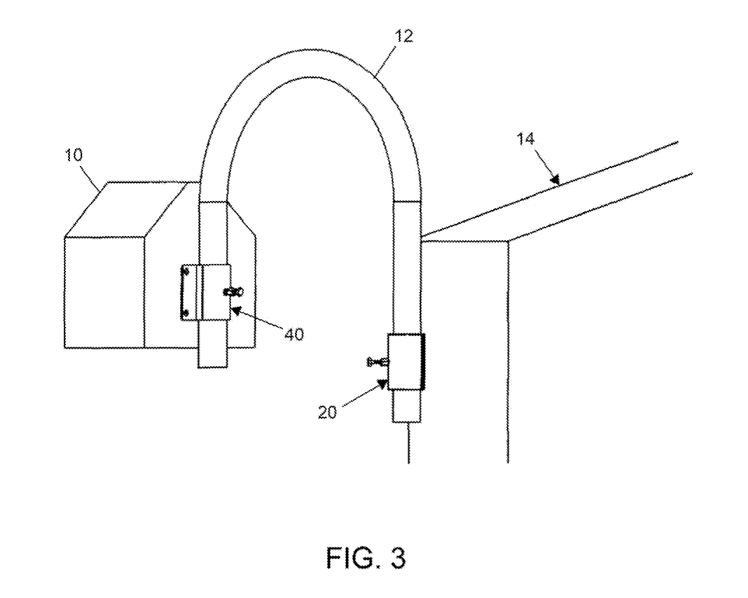

FIGS. 1 through 9 represent systems and components thereof suitable for mounting bird houses, animal feeders, or other similar structures intended to be elevated above their surroundings. FIGS. 1 through 3 represent such an elevated structure 10 fixed in an elevated position relative to a rigid base structure 14 with a cylindrical pole 12. Although represented as straight in FIGS. 1 and 2 and curved in FIG. 3, the pole 12 may have various cross-sectional and longitudinal shapes. The base structure 14 may be any rigid body, such as but not limited to a post, wall, or building, that is capable of supporting the weight of the elevated structure 10, the pole 12, and components of the system described below. For convenience, consistent reference numbers are used throughout the drawings to identify the same or functionally equivalent elements.

As represented in FIGS. 1 through 3, the systems utilize one or more mounting apparatuses 20, 40, and/or 50 configured to releasably couple the elevated structure 10 to the pole 12 and/or the pole 12 to the base structure 14. These mounting apparatuses 20, 40, and 50 are intended to promote stability (for example, against strong winds), promote ease of release from the pole 12 and base structure 14, promote an extended life cycle of the system and the elevated structure 10 it supports, and reduce the likelihood of tampering by animals. Various materials can be used to construct the apparatuses 20, 40, and 50, with preferred materials being resistant to moisture and other environmental conditions in which the apparatuses 20, 40, and 50 are to be used.

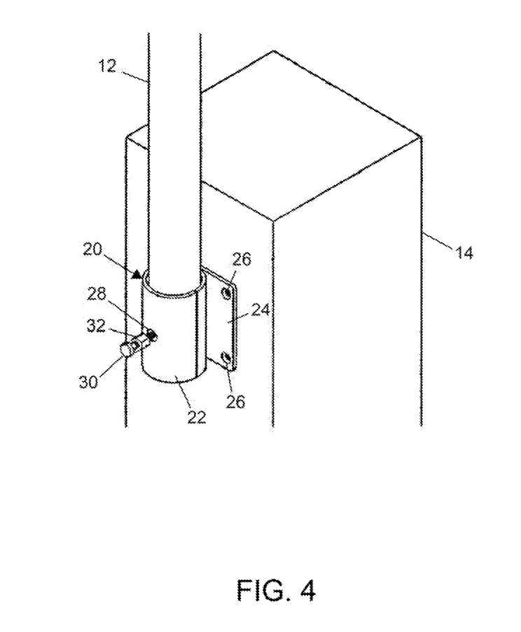

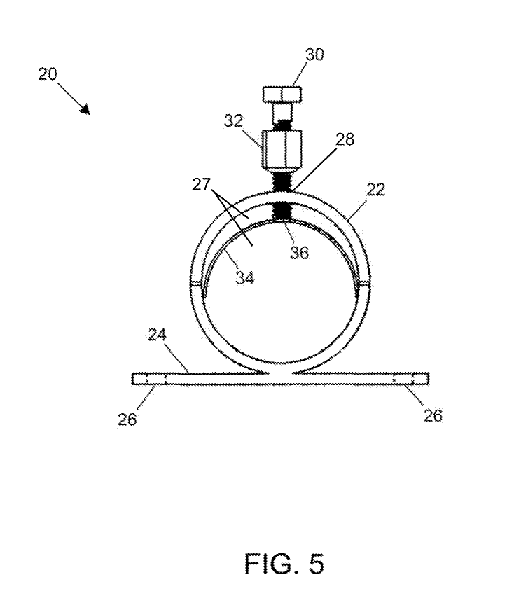

FIGS. 4 and 5 represent the mounting apparatus 20 as including a cylindrical- or tubular-shaped outer member 22 fixed to a planar rectangular plate 24 along an exterior longitudinal side of the outer member 22. The outer member 22 has an entirely closed circumference to define and enclose an internal cavity 27, with only two oppositely-disposed end openings providing access to the cavity 27. The cavity 27 and end openings each have a cross-sectional shape congruous or otherwise substantially complementary to the pole 12, in this instance, a pole 12 with a circular cross-section, though other cross-sectional shapes and sizes are foreseeable for the pole 12 and, therefore, for the cavity 27 within the outer member 22. The mounting apparatus 20 may be secured by locating a face of the plate 24 against the base structure 14 and inserting fasteners (e.g., screws, nails, etc., not shown) through holes 26 and into the base structure 14. The holes 26 may be countersunk to at least partially receive heads of the fasteners.

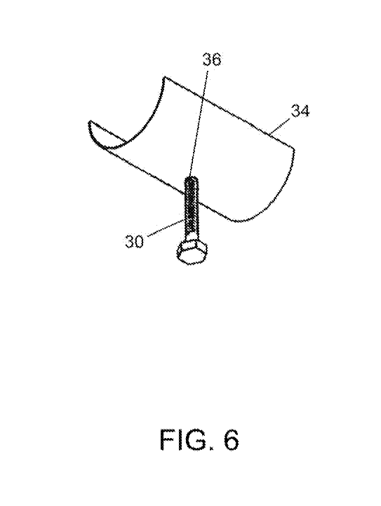

As represented in FIG. 5, the mounting apparatus 20 further includes an inner member 34 that is shown apart from the mounting apparatus 20 in FIG. 6. The inner member 34 has an outer surface generally congruous to or otherwise substantially complementary to an inner surface of the outer member 22 within its cavity 27, and having an outer surface generally congruous or otherwise complementary to an outer surface of the pole 12. In the illustrated embodiment, the inner and outer surfaces of the inner member 34 have semicircular or otherwise arcuate cross-sectional shapes that are complementary to the arcuate shape of the inner surface of the outer member 22 and the arcuate shape of the pole 12, which result from their cylindrical cross-sectional shapes, though other cross-sectional shapes and sizes are foreseeable for the inner and outer surfaces of the inner member 34 that may or may not complement the shape of the outer surface of the pole 12. The inner member 34 is shown as being connected to one end 36 of an adjustment bolt 30 having a head located outside of the outer member 22 and a threaded shank threadably engaged with and passing through a threaded hole 28 in the outer member 22 and into its internal cavity 27. For example, the inner member 34 may be connected to the end 36 of the bolt 30 by a rivet, axle, or other connection that enables the bolt 30 to rotate about its longitudinal axis and relative to the inner member 34. The adjustment bolt 30 is threaded through a threaded hole 28 in the outer member 22. The extent to which the bolt 30 is threaded into the outer member 22 can be fixed with a locking nut 32, and rotation of the bolt 30 can be performed with a tool (not shown) configured to engage the head of the bolt 30.

The inner member 34 is substantially prevented from rotating within the outer member 22 as a result of their complementary shapes, which results in contact between the outer and inner members 22 and 34 if the inner member 34 were to be rotated within the outer member 22. Rotation of the bolt 30 causes the end 36 of the bolt 30 to be further inserted into or retracted from the cavity 27, depending on the direction of rotation, thereby converting rotational movement into linear movement. Consequently, this action causes the inner member 34 to move perpendicular to the longitudinal axis of the outer member 22 and in directions toward or away from the plate 26, again depending on the direction of rotation of the bolt 30. Once the inner member 34 is suitably clamped against the pole 12 by the bolt 30, the nut 32 may be rotated to engage the outer surface of the outer member 22 surrounding the hole 28, thereby assisting to lock the position of the bolt 30 relative to the outer member 22. The nut 32 and the entrance to the hole 28 may be chamferred to provide smooth surface-to-surface contact and reduce wear during rotation of the nut 32.

With this configuration, the mounting apparatus 20 may be secured to the pole 12 by inserting the pole 12 through either of the two end openings of the outer member 22 and into the cavity 27 thereof at least to a position at which the inner member 34 is located between the pole 12 and a wall portion of the outer member 22. The adjustment bolt 30 may then be rotated to cause the inner member 34 to move in a direction toward the plate 24 such that the inner member 34 presses against the pole 12 and creates surface-to-surface clamping of the pole 12 between the inner member 34 and an oppositely-disposed portion of the outer member 22. As such, the inner member 34 and bolt 30 may be collectively referred to as a clamping assembly. Preferably, the complementary shapes of the inner member 34 and pole 12 provide a relatively large contact surface area therebetween to avoid individual wear points. It is foreseeable that the inner member 34 may extend along the entirety or a majority of the longitudinal length of the outer member 22 or even protrude from the outer member 22. As represented by the nonlimiting embodiment of FIG. 5, the curvature of the inner member 34 may be sufficient to contact up to half of the exterior circumference of that portion of the pole 12 within the cavity 27. The size and materials of the outer member 22, inner member 34, and bolt 30 can be selected so that the clamping force generated therewith can be tailored to be appropriate for the size of the pole 12 and the elevated structure 10 it supports.

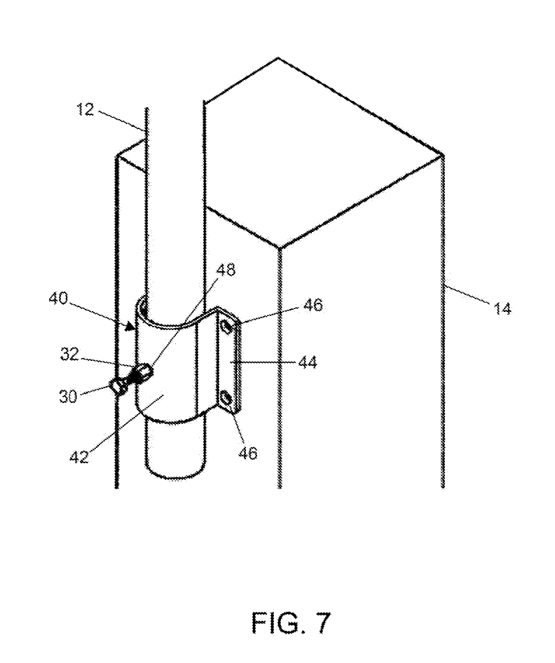

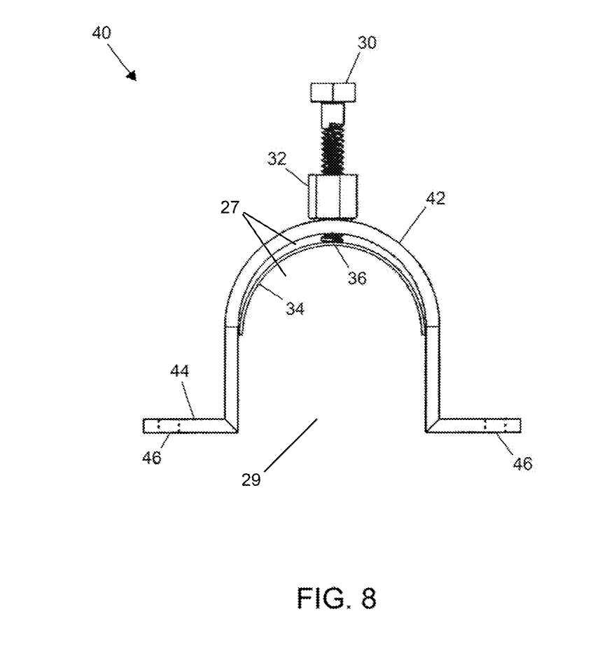

FIGS. 7 and 8 represent another of the mounting apparatuses (mounting apparatus 40) depicted in FIGS. 1 through 3. In view of similarities between the mounting apparatuses 20 and 40, the following discussion of the mounting apparatus 40 will focus primarily on aspects of the mounting apparatus 40 that differ from the first mounting apparatus 20 in some notable or significant manner. Other aspects of the mounting apparatus 40 not discussed in any detail can be, in terms of structure, function, materials, etc., essentially as was described for the first mounting apparatus 20.

FIGS. 7 and 8 represent the mounting apparatus 40 as including an outer member 42 assembled with the inner member 34, adjustment bolt 30, and nut 32 (clamping assembly) in a manner similar to the mounting apparatus 20 of FIGS. 4 through 6. In contrast to the outer member 22 shown in FIG. 5, the outer member 42 of the mounting apparatus 40 is represented in FIG. 8 as having a circumference that is not entirely closed, such that the outer member 42 defines an internal cavity 27 that is open not only at two oppositely-disposed end openings of the outer member 42, but also along a longitudinal side opening 29 of the outer member 42. The outer member 42 includes a wall opposite the side opening 29, and at least a portion of the wall has a cross-sectional shape congruous or otherwise complementary to the shape of the pole 12 and the inner member 34, in this instance, a semicircular shape that is complementary to the semicircular cross-sectional shape of the inner member 34 and complementary to a cylindrically-shaped outer surface of the post 12. The outer member 42 further includes a pair of planar portions that extend from the arcuate-shaped wall of the outer member 42 to define flanges 44 that protrude in opposite directions from the side opening 29. The mounting apparatus 40 may be secured by locating faces of the flanges 44 against the base structure 14 and inserting fasteners (e.g., screws, nails, etc., not shown) through holes 46 and into the base structure 14. The holes 46 may be countersunk to at least partially receive heads of the fasteners. Once the outer member 42 is secured to the base structure 14, its internal cavity 27 is enclosed between the outer member 42 and the base structure 14, with only the end openings providing access to the cavity 27.

Similar to what was described above for the mounting apparatus 20, the mounting assembly 40 may be secured to the pole 12 by inserting the pole 12 through one of its end openings into the cavity 27 of the outer member 42 at least to a position at which the inner member 34 is located between the outer member 42 and the pole 12. The adjustment bolt 30 may then be rotated within its threaded hole 48 to cause the inner member 34 to move in a direction toward side opening 29 such that the inner member 34 presses against the pole 12 and clamps the pole 12 between the inner member 34 and an oppositely disposed portion of the base structure 14.

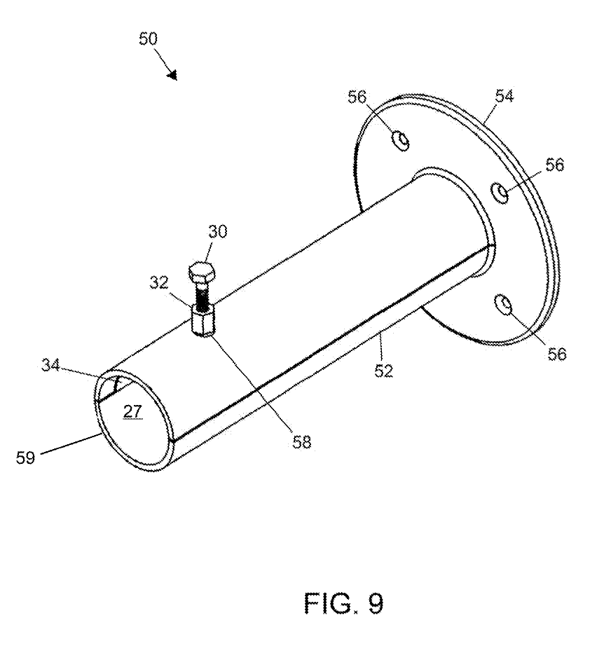

FIG. 9 represents the mounting apparatus 50 as including an outer member 52 assembled with the inner member 34, the adjustment bolt 30, and the nut 32 in a manner similar to the mounting apparatuses 20 and 40 of FIGS. 4 through 8. Similar to the outer member 22 of FIG. 5, the outer member 52 shown in FIG. 9 has a wall that completely circumferentially encloses an internal cavity 27, whose cross-sectional shape is congruous or otherwise complementary to the pole 12, in this instance a tubular pole having a circular cross-section. A circular plate 54 is located at a distal end of the outer member 54 that includes holes 56 for securing the third mounting apparatus 50 to the base structure 14 or elevated structure 10 with fasteners (not shown). The holes 56 may be countersunk to at least partially receive heads of the fasteners. The plate 54 may close one end of the outer member 52, in which case the outer member 52 has an entirely closed circumference to define and enclose the internal cavity 27, with only end opening 59 providing access to the cavity 27.

Similar to what was described above for the previous mounting apparatuses 20 and 40, the mounting apparatus 50 may be secured to the pole 12 by inserting the pole 12 into the cavity 27 of the outer member 42 through the end opening 59 at least to a position at which the inner member 34 is located between the outer member 52 and the pole 12. The adjustment bolt 30 may then be rotated within its threaded hole 58 to cause the inner member 34 to move in a direction toward the pole 12 such that the inner member 34 presses against the pole 12 and clamps the pole 12 between the inner member 34 and an oppositely-disposed portion of the outer member 52.

It is believed that the operation and structure of the inner member 34 provide benefits over conventional mounting devices used for bird houses, animal feeders, and the like by providing a relatively large and continuous contact surface area over which pressure can be distributed when clamping the pole 12 within the outer member 22, 42, or 52, instead of being concentrated at the end of a bolt. This configuration promotes stability, a prolonged life cycle, and ease of release. Further, since the inner member 34 may interact and clamp various portions of the pole 12, the mounting apparatuses 20, 40, and 50 disclosed herein allow a user to adjust the rotational orientation and vertical position of the elevated structure 10 by rotating the pole 12 and/or increasing or decreasing the length of the pole 12 that is inserted into the mounting apparatus 20, 40, or 50.

It should be understood that the mounting apparatuses 20, 40, and 50 are exemplary and the construction and operation of their clamping assemblies could be applied to mounting apparatuses having various configurations. In addition, the mounting apparatuses 20, 40, and 50 could be modified to accommodate poles of various sizes and shapes, or modified to further promote certain benefits provided by these apparatuses. For example, the clamping assemblies could include a relatively larger inner member to increase the contact surface area with a pole to further promote stability. In addition, the clamping assemblies may include two or more adjustment bolts 30 fixed at different locations to the inner member 34 to maintain a substantially even distribution of clamping pressure during use. The clamping assembly could also be modified to provide linear movement of the inner member 34 by other methods. For example, the adjustment bolt 30 could pass freely through the hole 28, 48, or 58 and be fixed at its end 36 to the inner member 34, so that only longitudinal translation of the bolt 30 occurs to move the inner member 34.

While the invention has been described in terms of specific embodiments, it is apparent that other forms could be adopted by one skilled in the art. For example, the physical configuration of the mounting apparatuses 20, 40, and 50, the elevated structure 10, the pole 12, and the base structure 14 could differ from that shown, and various materials could be used in their fabrication. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the phraseology and terminology employed above are for the purpose of describing the disclosed embodiments, and do not necessarily serve as limitations to the scope of the invention. Therefore, the scope of the invention is to be limited only by the following claims.

1. A mounting apparatus for removably securing a pole to a structure, the mounting apparatus comprising:
an outer member having a wall defining at least a portion of an internal cavity and an end opening to the internal cavity configured so that the pole can be received through the end opening into the internal cavity, the wall being elongated and having a longitudinal axis;
means for fixing the mounting apparatus to the structure;
an inner member located within the internal cavity, the inner member being elongated in a direction parallel to the longitudinal axis of the outer member and having a cross-sectional shape congruous or otherwise complementary to an exterior surface of the pole; and
means for moving the inner member within the internal cavity in directions perpendicular to the longitudinal axis of the outer member;
wherein the mounting apparatus is configured to secure the pole within the internal cavity by moving the inner member toward the pole to contact and apply pressure to the pole within the internal cavity of the outer member.

2. The mounting apparatus of claim 1, wherein the moving means for moving the inner member within the internal cavity comprises a threaded hole in the outer member and an adjustment bolt having a head located outside of the outer member and a threaded shank passing through the threaded hole and into the internal cavity, wherein an end of the adjustment bolt opposite the head is rotatably coupled to the inner member and wherein rotation of the adjustment bolt causes the adjustment bolt to move in linear directions through the threaded hole and thereby cause the inner member to move in directions perpendicular to the longitudinal axis of the outer member.

3. The mounting apparatus of claim 1, wherein the inner member comprises a wall with an inner surface having a semi-circular cross-sectional shape.

4. The mounting apparatus of claim 1, wherein the wall of the outer member is tubular and circumferentially closes the internal cavity.

5. The mounting apparatus of claim 4, wherein the fixing means for fixing the mounting apparatus to the structure comprises a planar plate fixed to an exterior longitudinal side of the wall of the outer member.

6. The mounting apparatus of claim 4, wherein the fixing means for fixing the mounting apparatus to the structure comprises a planar plate fixed to a longitudinal end of the wall opposite the end opening of the outer member.

7. The mounting apparatus of claim 1, wherein the wall of the outer member comprises a semi-circular portion partially surrounding the internal cavity and defining a longitudinal side opening along a longitudinal length of the outer member.

8. The mounting apparatus of claim 7, wherein the means for fixing the mounting apparatus to the structure comprises a planar plate that closes the longitudinal side opening of the wall.

9. A method of securing the pole to the structure with the mounting apparatus of claim 1, the method comprising:
securing the mounting apparatus to the structure;
inserting an end of the pole into the end opening of the outer member such that a portion of the pole is located between the inner member and the outer member or the structure; and
operating the moving means to cause the inner member to move in a direction toward the pole until the inner member contacts and clamps the pole between the inner member and the outer member or the structure.

10. The method of claim 9, further comprising operating the moving means to cause the inner member to move in a direction away from the pole until the inner member no longer contacts the pole and then removing the pole from the internal cavity.

11. The method of claim 9, wherein the structure is a rigid base structure and the pipe supports an elevated structure relative to the rigid base structure.

12. The method of claim 9, wherein the structure is an elevated structure that is supported by the pipe relative to a rigid base structure.

13. A system for fixing a first structure in an elevated position relative to a rigid base structure, the system comprising a pole configured to support the first structure in the elevated position and at least one mounting apparatus configured for clamping the pole, the mounting apparatus comprising:
an outer member having a wall defining at least a portion of an internal cavity and an end opening to the internal cavity configured so that the pole can be received through the end opening into the internal cavity, the wall being elongated and having a longitudinal axis;
means for fixing the mounting apparatus to the first structure or the rigid base structure;
an inner member located within the internal cavity, the inner member being elongated in a direction parallel to the longitudinal axis of the outer member and having a cross-sectional shape congruous or otherwise complementary to an exterior surface of the pole; and
means for moving the inner member within the internal cavity in directions perpendicular to the longitudinal axis of the outer member;
wherein the mounting apparatus is configured to clamp the pole within the internal cavity by moving the inner member toward the pole to contact and apply pressure to the pole within the internal cavity of the outer member.

14. The system of claim 13, wherein the moving means for moving the inner member within the internal cavity comprises a threaded hole in the outer member and an adjustment bolt having a head located outside of the outer member and a threaded shank passing through the threaded hole and into the internal cavity, wherein an end of the adjustment bolt opposite the head is rotatably coupled to the inner member and wherein rotation of the adjustment bolt causes the adjustment bolt to move in linear directions through the threaded hole and thereby cause the inner member to move in directions perpendicular to the longitudinal axis of the outer member.

15. The system of claim 13, wherein the inner member comprises a wall with an inner surface having a semi-circular cross-sectional shape.

16. The system of claim 13, wherein the wall of the outer member is tubular and circumferentially encloses the internal cavity.

17. The system of claim 16, wherein the fixing means comprises a planar plate fixed to an exterior longitudinal side of the wall.

18. The system of claim 16, wherein the fixing means comprises a planar plate fixed to a longitudinal end of the wall opposite the end opening of the outer member.

19. The system of claim 13, wherein the wall of the outer member comprises a semi-circular portion partially surrounding the internal cavity and defining a longitudinal side opening along a longitudinal length of the outer member, and the fixing means comprises a planar plate that closes the longitudinal side opening of the wall.

20. A method of securing the pole to the first structure and the rigid base structure with the system of claim 13, the method comprising:
securing the mounting apparatus to the first structure or the rigid base structure;
inserting a first end of the pole into the end opening of the outer member of the mounting apparatus such that a first portion of the pole is located between the inner member and the outer member of the mounting apparatus or between the inner member and the first structure or the rigid base structure; and
operating the securing means to cause the inner member to move toward the pole until the inner member contacts and clamps the pole between the inner member and the outer member of the mounting apparatus or between the inner member and the first structure or the rigid base structure.
